(19) United States
(12) Patent Application Publication
(10) Pub. No.: US 2010/0223158 A1
(43) Pub. Date: Sep. 2, 2010

(54) System and Method for Vehicle Retail Sales, Distribution, and Post-Sales Maintenance

(75) Inventors: Julie Nguyen Brown, Dearborn, MI (US); Keith Allen Godin, Dearborn, MI (US)

Correspondence Address: BROOKS KUSHMAN P.C., 1000 TOWN CENTER, TWENTY-SECOND FLOOR, SOUTHFIELD, MI, 48075, US

(73) Assignee: PLASTECH HOLDING CORP., Dearborn, MI (US)

(21) Appl. No.: 12/715,050

(22) Filed: Mar. 1, 2010

Related U.S. Application Data
(60) Provisional application No. 61/156,274, filed on Feb. 27, 2009.

(51) Int. Cl. G06Q 50/00; G06Q 30/00; G06Q 40/00; G06Q 10/00; G06Q 99/00

(52) U.S. Cl. 705/27; 709/206

(57) ABSTRACT

An online method for vehicle retail sales, distribution, and post-sales maintenance includes a series of computer processor implemented steps. The method includes steps of providing vehicle-related information to a customer, receiving vehicle-related selections from the customer specifying a vehicle that the customer is to purchase, communicating relevant selections to business partners, receiving an order submission from the customer, and processing the order submission. One or more of the vehicle-related selections at least partially require products or services from a business partner. The method of the present embodiment further comprises receiving a bridge vehicle request from the customer. A computer system implementing the method is also provided.

### CROSS-REFERENCE TO RELATED APPLICATIONS

This application claims the benefit of U.S. provisional Application No. 61/156,274, filed Feb. 27, 2009, the disclosure of which is incorporated in its entirety by reference herein.

### BACKGROUND

1. Technical Field

One or more embodiments include a system and method for vehicle retail sales, distribution, and post-sales maintenance.

2. Background Art

The typical process for distributing cars via vehicle dealerships in the United States has been in use for almost 100 years. Because vehicle manufacturers had limited capital when they established distribution systems, dealerships were set up as independent businesses rather than company-owned stores. As a result, the vehicle manufacturers had little direct contact with their ultimate customers and limited control over dealerships selling their vehicles. One related concern of the vehicle manufacturer is that dealerships may focus on the immediate sale and short-term profitability, rather than building a brand (“goodwill”) for the longer term. Accordingly, these differences in objectives have culminated into increasing strains on the business relationship between the dealers and the automakers and, as a result, customer dissatisfaction. For example, it is reported that 60% of customers are dissatisfied with the present system.

In recent years, US and Foreign vehicle manufacturers have attempted to improve the situation, but have been largely constrained by current agreements and state laws. Some have attempted to provide immediate or direct sale to their customers. However, these manufacturers limited what they offered to their customers. For example, customers could not test drive vehicles unsupervised for an extended period of time. Currently, test drives are usually with a salesman for short periods of time.

Rental car companies also sell used vehicles through their websites from which a customer may purchase a vehicle. Rental companies, however, are not subject to the same agreements and laws as those to which vehicle manufacturers or distributors are bound. Rental car companies typically sell vehicles that are in their inventory. A customer cannot, for example, configure a vehicle to his/her liking. Moreover, rental car companies today are not allowed to perform maintenance on new vehicles post sales.

Accordingly, there is a need for need methods and systems of selling vehicles.

### SUMMARY OF INVENTION

Against this prior art background, an online method for vehicle retail sales, distribution, and post-sales maintenance is provided. The method of this embodiment includes a series of computer processor implemented steps which include steps for providing vehicle-related information to a customer, receiving vehicle-related selections from the customer specifying a vehicle that the customer is to purchase, communicating relevant selections to business partners (i.e., service or parts providers), receiving an order submission from the customer, and processing the order submission. One or more of the vehicle-related selections at least partially require products or services from a business partner. The method of the present embodiment further comprises receiving a bridge vehicle (i.e., a loaner or lease vehicle) request from the customer.

In another embodiment of the present invention, a method for vehicle retail sales, distribution, and post-sales maintenance is provided. The method of this embodiment includes a series of computer processor implemented steps which include steps for providing vehicle-related information to a customer, receiving vehicle-related selections from the customer specifying a vehicle that the customer is to purchase, communicating relevant selections to business partners (i.e., service or parts providers), receiving an order submission from the customer, processing the order submission, and receiving evaluations for business partners from the customer. One or more of the vehicle-related selections at least partially require products or services from a business partner. The method of the present embodiment further comprises receiving a bridge vehicle (i.e., a loaner or lease vehicle) request from the customer. Advantageously, a business partner may voluntary elect not to participate in the method of this embodiment if the evaluation related to that partner is low or such a partner may be involuntarily barred from participating.

In another embodiment of the invention, an online system for vehicle retail sales, distribution, and post-sales maintenance that implements the methods set forth above is provided. The system of the present invention comprises a computer processor operable to provide vehicle-related information to a customer, receive vehicle-related selections from the customer specifying a vehicle that the customer is to purchase, receive a vehicle service request from the customer, the service request identifying business partner that is a service provider, communicate relevant selections to business partners, receive an order submission from the customer, receive a bridge vehicle request from the customer, the bridge vehicle being a loaner or lease vehicle, and process the order submission. Characteristically, one or more of the vehicle-related selections require products or services from a business partner. The system of this embodiment is a coordinated online system of virtual integration between partners/providers to support a full “vehicle purchase through maintenance” life cycle for every customer.

In still another embodiment of the invention, an online system for vehicle retail sales, distribution, and post-sales maintenance that implements the methods set forth above is provided. The system of the present invention comprises a computer processor operable to provide vehicle-related information to a customer, receive vehicle-related selections from the customer specifying a vehicle that the customer is to purchase, receive a vehicle service request from the customer, the service request identifying business partners that are service providers, communicate relevant selections to business partners, receive an order submission from the customer, receive a bridge vehicle request from the customer, the bridge vehicle being a loaner or lease vehicle, process the order submission, and receive evaluations about the business partners from the customer. Characteristically, one or more of the vehicle-related selections require products or services from a business partner. The system of this embodiment is a coordinated online system of virtual integration between partners/providers to support a full “vehicle purchase through maintenance” life cycle for every customer. Advantageously, a business partner may voluntary elect not to participate in the online system of this embodiment if the evaluation related to that partner is low or such a partner may be involuntarily removed from the system.

In yet another embodiment of the present invention, a computer readable medium is provided. The computer readable medium is encoded with instructions for carrying out one or more steps of the methods set forth above.

Advantageously, at least some of the methods and systems of the present invention link all relevant aspects of vehicle retail sales, distribution, and maintenance (e.g., marketing, order development, purchase, financing, delivery and service) for direct use by a vehicle customer. The methods and systems optionally allow direct communication between the customer and the vehicle manufacturer or distributor while providing complete transparency in vehicle pricing and services.

### BRIEF DESCRIPTION OF THE DRAWINGS

The invention, both as to its exemplary organization and illustrative manner of operation, together with further objects and advantages thereof, may best be understood with reference to the following description, taken in connection with the accompanying drawings, in which:

FIG. 1 illustrates a retail sales, distribution, and post-sales maintenance system according to one of the various embodiments of the present invention;

FIG. 2 illustrates the operation of the retail sales, distribution and post-sales maintenance system according to one of the various embodiments of the present invention;

FIG. 3 provides a schematic illustration of interactions during the pre-sale and sale phase of a vehicle purchase;

FIG. 4 provides a schematic illustration of interactions during the after vehicle phase of a vehicle purchase;

FIG. 5 provides a flowchart illustrating the utilization of the website depicted in FIGS. 3 and 4 from a customer's perspective;

FIG. 6 provides a flowchart illustrating the utilization of the website depicted in FIGS. 3 and 4 from a business partner and administrator perspective;

FIG. 7 provides a flowchart depicting the steps by which a customer initiates the building of a vehicle;

FIG. 8 provides a flowchart illustrating the implementation of a “kick the tires” functionality;

FIG. 9 provides a flowchart illustrating steps for scheduling a test drive;

FIG. 10 provides a flowchart illustrating steps for pre-approving a customer for a vehicle purchase;

FIG. 11 provides a flowchart illustrating steps for purchasing a vehicle;

FIG. 12 provides a flowchart illustrating steps for defining a payment plan for a vehicle purchase;

FIG. 13 provides a flowchart illustrating the steps related to providing proof of insurance to the purchase vehicle;

FIG. 14 provides a flowchart illustrating the end of vehicle order process;

FIG. 15 provides a flowchart illustrating the steps for a vehicle loan approval;

FIG. 16 provides a flowchart illustrating the steps involved in batching vehicle orders to the vehicle;

FIG. 17 provides a flowchart illustrating the steps involved in the trade-in process;

FIG. 18 provides a flowchart illustrating the steps implemented by the retail sales, distribution, and post-sales maintenance system in fulfilling a bridge vehicle request;

FIG. 19 provides a flowchart illustrating the steps for vehicle or part delivery in accordance with an embodiment of the invention;

FIG. 20 provides flowcharts illustrating the steps involved in the system sending maintenance notifications;

FIG. 21 provides a flowchart illustrating the steps involved in scheduling maintenance;

FIG. 22 provides a flowchart illustrating the steps involved in purchasing parts.

### DETAILED DESCRIPTION OF THE VARIOUS EMBODIMENTS

As required, detailed embodiments of the present invention are disclosed herein. However, it is to be understood that the disclosed embodiments are merely exemplary of an invention that may be embodied in various and alternative forms. Therefore, specific functional details disclosed herein are not to be interpreted as limiting, but merely as a representative basis for the claims and/or as a representative basis for teaching one skilled in the art to variously employ the present invention.

The present invention is described herein within the context of vehicle retail sales, distribution and post-sales maintenance. It should be understood, however, that this is provided by way of example only and that the present invention may be used in other retail distribution and maintenance environments.

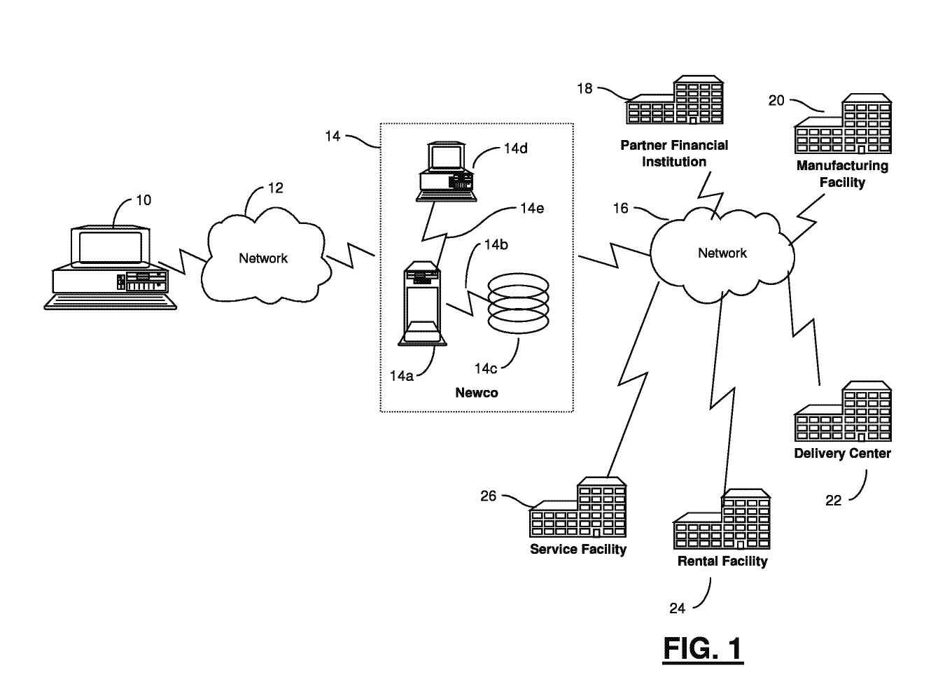

As represented in FIG. 1, an exemplary system (“the System”) for vehicle retail sales, distribution, and post-sales maintenance according to one or more embodiments of the present invention is presented. As illustrated, a user from user terminal 10 may access entity 14 (hereinafter referred to as “Newco 14”) over a communication network 12. The communication network 12 may provide access to the Internet through a number of communication lines including, but not limited to, T-1, cable, dial-up, cellular network, and DSL. In one embodiment, terminal 10 may be a personal computer (PC) such as a laptop or desktop, a PDA, cell phone, smartphone, or any other Internet-accessible user device having an Internet browser. In another embodiment, terminal 10 may be a kiosk located in a vehicle retail store or showroom. The kiosk may provide for access to the Internet via a web-based browser. The vehicle retail store/showroom (either reality or virtual reality/image-based) may or may not be owned and operated by Newco 14. As used herein, Newco 14 includes non-dealership entities. It would be appreciated that the Newco 14 may include effectively a virtual office. It need not be limited to a physical structure, for example, one fabricated from bricks and mortar.

From terminal 10, a user may communicate via network 12 with server 14a. In one embodiment, server 14a may be a web server for generating and transmitting web pages to a user at terminal 10. Server 14a may receive the information transmitted from user terminal 10 and include instructions for performing the operations of one or more embodiments of the present invention, as will be described below. Typically, server 14a includes one or more computer processors for performing these operations. The term “computer processor” as used herein will be understood to include one or more computer processors unless otherwise indicated. In various refinements, the computer processor is operable to perform one or more of the steps of the methods set forth below. The instructions may be stored on a computer-readable medium in communication with the server 14a (e.g., computer memory or storage devices including, but not limited to, CDs, DVDs and Flashdrives). In one embodiment, the user may download software to his/her (hereinafter “his”) terminal 10 from server 14 for performing the various embodiments of the present invention. Server 14a may be in communication via communication link 14b (e.g., Intranet, LAN, and WAN) with database 14c.

Database 14c may include data relating to a number of customers. Non-limiting examples include customer profile information (e.g., personal and financial information), information about a customer's vehicle (e.g., specifications of his vehicle to be purchased), a customer's warranty and service record, and the customer's rental history. The information stored in database 14c may be considered a “master list” of all customer information relating to him and his vehicle. In one embodiment, database 14c may also include information relating to vehicles wholly owned by Newco 14. Thus, as will be described below, if a user wishes to rent a vehicle for a test drive or while waiting for the arrival of his purchased vehicle, a user may choose to rent a vehicle from a rental facility 24 or a vehicle owned by Newco 14. Database 14c may also include vehicle configuration information (e.g., color, engine-type, number of doors).

In one embodiment, server 14a may be in further communication via connection 14e with terminal 14d. Terminal 14d may be utilized, for example, by a system administrator, customer service representative or other persons associated with Newco 14. Non-limiting examples of uses of terminal 14d may be website updates, communication with user at terminal 10, system administration, and communication with business partners (e.g., financial institutions, vehicle manufacturer, delivery center, etc).

Newco 14 may communicate through, for example, server 14a via network communication 16 (e.g., the Internet) with one or more partners (hereinafter referred to as “Business Partners”) associated with accomplishing one or more objectives of the various embodiments of the present invention. Such Business Partners typically are service or product (the vehicle and parts) providers that assist as set forth below in the system and methods of the invention. In practice, it will be appreciated that network 12 need not be isolated from network 16. In fact they could be at least partially coextensive. Business Partners may include, but are not limited to, partner financial institutions 18, vehicle manufacturers 20 which need not be located offshore, vehicle distribution and delivery centers 22, rental facilities 22, service facilities 26, and dealer agents. It should be understood that the Business Partners are exemplary and other partners may be used. Furthermore, it should be understood that at least one of the Business Partners may be used. That is, not all of the Business Partners may be involved in a transaction. Alternatively, any combination of Business Partners may be used in a transaction.

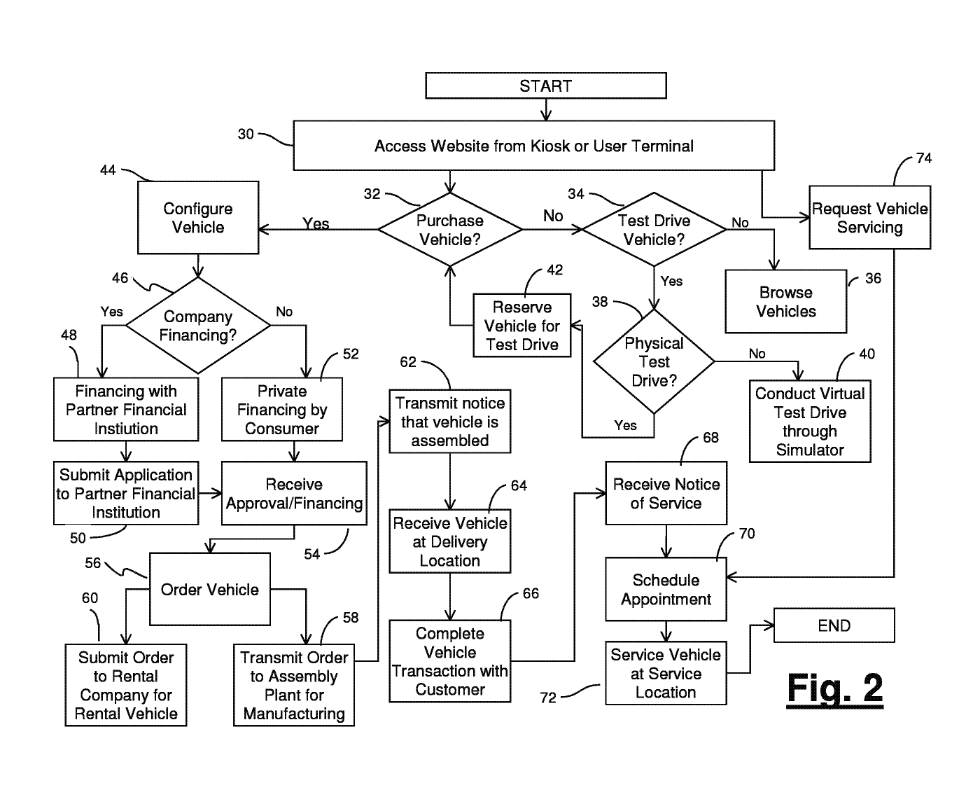

As represented in FIG. 2, the operation of the vehicle retail sales, distribution, and post-sales maintenance system is presented according to one of the various embodiments of the present invention. In block 30, users may access a website from terminal 10 and may or may not be required to log on to the website using a username and password. In one embodiment, a user may access the website to configure vehicles or “browse” the website which may not require a log on. If the user decides to purchase a vehicle, however, the user may be required to register on to the website (if the user has not already done so), generate a profile, and log-on to the website. In one embodiment, the website may be restricted requiring all users to register prior to using the website. When a user generates a profile, they may enter all personal information (e.g., name, address, social security number, driver's license number) and financial information (e.g., household income) for accomplishing the purchase of a vehicle. In one embodiment, a user may enter financial information only when he chooses to finance a vehicle.

A user may or may not want to purchase a vehicle as in block 32. If a user does not want to purchase a vehicle, he or she may be asked if they would like to test drive a vehicle as in block 34. If the user would like to test drive a vehicle, the user may choose whether they would like a physical test drive (i.e., test drive an actual vehicle) or have a “virtual test drive” as in block 38. If the user does not want a physical test drive, they may be given the option to have a “virtual test drive” as in block 40. A user may have a “virtual test drive” using terminal 10 in a showroom (e.g., a kiosk) or in another location using terminal 10 having a vehicle simulator.

The vehicle simulator may be programmed software stored in terminal 10 or server 14a. Using a vehicle simulator, a user may input a configuration of a vehicle he is interested in purchasing. Using the inputted information, the vehicle simulator may simulate a number of vehicle experiences. For example, the simulator may simulate the driving dynamics of the powertrain of a vehicle. In another example, the user may view his inputted vehicle configuration (e.g., 2-door, 4-door, hatchback and color) with the user located in the driver's seat. It should be understood that these examples are not limiting and are merely illustrative.

Alternatively or additionally, a user may request a physical test drive through the website using user terminal 10. After a user makes a request for a physical test drive, server 14a may communicate with a Business Partner (e.g., rental facility 24) to reserve a vehicle as in block 42 for the user to test drive based on the type of and configuration of the vehicle the user wishes to test drive. The vehicle used for a test drive may or may not include the same options and configurations requested by the user. In one embodiment, rental facility 24 may be a facility owned by Newco 14 with vehicles owned by Newco 14 and/or a vehicle manufacturer. Server 14a may communicate with one or more systems (e.g., databases (not shown)) at rental facility 24 for retrieving an inventory of vehicles which may be available to the user for a test drive. The inventory of vehicles may then be displayed to the user at terminal 10. In one embodiment, the user may be directed to a rental facility's website in order to select a vehicle the user wishes to test drive. Alternatively, in another embodiment, a user may be able to select a limited amount of vehicles owned by Newco 14 for a test drive.

When choosing to physically test drive a vehicle, users may be given a significant discount for a fixed number of days or hours to test drive the vehicle. For example, a user may be able to “test drive” the vehicle for 5 days at a discounted fixed rate per day. As will be further described below, upon purchasing a configured vehicle, a user may also be given a rental vehicle during the period of time that his or her vehicle is being manufactured. Reserving a rental vehicle may operate in the same manner as described above. In a refinement, the rental car company may own the test drive vehicles. They may rent them as normal rental cars or use them as test drive cars.

With reference back to FIG. 2, if a user does not want to test drive a vehicle, a user may continue to browse the website or exit the website as in block 36.

A user may be interested in purchasing a vehicle. In such a case, a user may configure a vehicle they are interested in purchasing as in block 44. A user may configure his vehicle by selecting one or more options listed on a user interface (e.g., a web page) displayed on terminal 10. Non-limiting examples of options include vehicle color, number of doors, whether he would like a sedan or hatchback, whether he would like an all-wheel drive vehicle or a front-wheel drive vehicle, etc. In one embodiment, a user may generate a variety of configurations and save them in, for example, a “history” folder on the website. The various configuration options may be presented to a user through, for example, drop-down menus or check boxes for the user to select.

The configuration selected by the user from terminal 10 may be communicated to database 14c which may include vehicle configuration information. In one embodiment, database 14c, after receiving one or more of a user's vehicle configuration options, may look up each option in one or more tables and transmit the information to display the configured vehicle to the user through communication with server 14a.

After configuring a vehicle, the user may then order/purchase his configured vehicle as in block 56. Before, during, or after the ordering of a vehicle, a user may or may not require vehicle financing provided by Newco 14 as in block 46. A user may make this selection by, for example, selecting a company financing option from the website at terminal 10.

If the user does require company financing as in block 48, server 14a may interface/communicate with one or more systems (not shown) of one or more partner financial institutions 18 to retrieve financial information about the user including, but not limited to, financing quotes, credit scores, a user's debt history and other financial information. Financial institutions include, but are not limited to, banks and credit agencies. A user may apply for company financing from terminal 10 through the website. In one embodiment, server 14a may retrieve financial information (e.g., household income) about the user that may have been inputted by user during registration. Thus, during the application process, some financial information about the user may automatically be provided on the electronic application.

The electronic application may then be transmitted to one or more partner financial institutions 18 as in block 50. Server 14a may then receive an approval as in block 54 for the user which may be transmitted to the user. In one embodiment, the user may receive an immediate approval for financing.

If the user does not require company financing, the user may indicate this option on the website (e.g., by selecting “I do not want company financing”) as in block 52. The user may receive a message at terminal 10 to verify financing approval from his private financial institution as in block 54. Non-limiting examples of verification include a deposit of funds from user's financial institution to partner financial institution 18, an approval/commitment letter and/or a letter of credit. A deposit of funds may be achieved, for example, by authorizing the user to make a deposit to a deposit account at partner financial institution 18. Verification of the deposit may be made automatically or manually (e.g., by personnel at Newco 14). In one embodiment, the message may indicate that the user may not proceed with ordering a vehicle until he is approved by his financial institution.

In one embodiment, whether the user is using company financing or private financing, a user may not have the ability to proceed with ordering a vehicle until financing has been arranged.

Newco 14 may offer credit cards for potential and current customers of the system offered through, for example, partner financial institution 18. A user may transmit a credit card application for approval through the website using terminal 10. In one embodiment, if a user receives an approval, he may be also be approved for purchasing a vehicle through the credit card at the same time or at a later time (e.g., by being given a sufficient credit line). Monthly car payments may also be made through the credit card received through Newco 14 or another credit card.

A user may also trade-in his vehicle as a way of financing his purchase of a vehicle. A user may indicate on the website, prior to submitting an ordering to manufacturing facility 20, that he wishes to trade-in a vehicle. Newco 14 may then display a non-binding or binding estimate of the vehicle to be trade-in to the user at terminal 10. In one embodiment, if the user desires, he may print out the estimate from a printer (not shown) in communication with terminal 10. Server 14a may communicate with database 14c which may store an estimation engine (e.g., an engine provided by the Kelley Blue Book Co., Inc.) or communicate with an external system providing an estimation engine. In one embodiment, a user may be requested to take the vehicle to be traded-in into delivery center 22 or rental facility 24 for a physical inspection and a trade-in quote. The quote may then be used toward the purchase of a vehicle.

Upon receiving all the appropriate information about the vehicle and the user, the order may then be transmitted to a manufacturing facility 20 for assembly as in block 58. In a refinement, the system utilizes a “pull” methodology (i.e., no inventory), allowing customers to purchase vehicles via a build to order system. The data may be transmitted as the orders are placed. Alternatively or additionally, the orders may be collected by server 14a and transmitted in batches to the manufacturing facility 20 at predetermined times (e.g., nightly). The orders may be transmitted to a database (not shown) at manufacturing facility 20 which may be accessed (e.g., via a portal or intranet site) by the manufacturing facility 20 to retrieve the orders and display the orders at one or more terminals (not shown) at manufacturing facility 20. In one embodiment, physical and electronic reports of to-be-manufactured vehicles may be generated at manufacturing facility 20. In one embodiment, manufacturers will have access to the same website used by users with private access to retrieve the orders from server 14a.

A user may track the manufacturing of their vehicle by, for example, their order number. For example, automated emails may be transmitted to the user at predetermined times informing them of the manufacturing status of their vehicle. Additionally or alternatively, the user may receive updates by logging on to the website. One of ordinary skill in the art will know and understand how to achieve the benefits of this feature.

A user may receive a notice that his or her vehicle has been assembled and is ready for delivery as in block 62. Non-limiting examples of notices include automated emails, text messages, status updated received by logging on to the website, or notice received via postal mail. In one embodiment, the user may track the delivery of his or her vehicle by, for example, a vehicle identification number (VIN) or order number. The user may receive tracking information such as port of departure, port of entry, an expected delivery date, an actual delivery date, destination of the vehicle, and other tracking information. In one embodiment, the destination information may be based on user preferences. For example, the user may want the vehicle delivered to his or her home or office rather than to the delivery/distribution center 22. Delivery preference may be established by the user during registration.

The vehicle may then be received at a delivery center 22 (or at another location based on a user's preference) as in block 64. The user may receive an electronic notice (e.g., via email or text message) or physical notice (e.g., via postal mail) that the vehicle has arrived. The notice may be transmitted/sent from manufacturing facility 20 to a user via Newco 14. Alternatively, the notice may be electronically or physically generated from manufacturing facility 20 and sent directly to the user. Upon receiving the vehicle at the delivery location, the vehicle transaction may be completed with the customer as in block 66 (e.g., exchange of tags and title and delivery of keys).

In one embodiment, a user may choose to receive a rental vehicle for use during the time that their vehicle is being manufactured and shipped (e.g., 2 months). Accordingly, upon ordering the vehicle, an order to a rental vehicle facility 24 may be transmitted from server 14a as in block 60. Alternatively, a user may choose to rent a vehicle owned by Newco 14 in which case a vehicle reservation is made with Newco 14 for the user. A user may order a rental vehicle in the manner described above. It should be understood that “rental vehicle” includes bridge vehicles and “rental facility” includes a vehicle loaning facility.

In one embodiment, a user may be given a significant discount for renting a vehicle during the manufacturing period. For example, a user may be given (e.g., electronically or through the mail) a certificate or coupon for renting a vehicle for $5 per day or at no cost. The coupon may or may not be redeemed at rental facility 24 or with Newco 14. In another refinement, the bridge car is leased at a monthly rate that is somewhat lower than the normal car payment that would be required for a new car.

A user may also be offered a variety of additional services. For example, a user may purchase vehicle parts, vehicle insurance, and roadside assistance (e.g., AAA coverage). Additionally, a user may arrange servicing of his or her vehicle using the system as described in one or more embodiments. A user may request a servicing as in block 74 from the website without purchasing or ever having purchased a vehicle through Newco 14. That is, a user need not be a current or previous customer to request a service of his vehicle. Accordingly, Newco 14 may be an entity facilitating all aspects of vehicle ownership (e.g., from sale and manufacturing to engineering to post-sale maintenance).

Alternatively or additionally, a user may receive a notice transmitted from server 14a that a servicing of their vehicle is required as in block 68. Servicing schedules may be pre-programmed to software on server 14a based on the history of a vehicle or on regular maintenance intervals. Server 14a may generate the notice to user based on these servicing schedules. The user may receive the notice by, for example, an automated email, telephone call, or other communication means.

A user may schedule an appointment for service as in block 70 using the system. Newco 14 may partner with an external vehicle service facility 26. Accordingly, once the user makes an appointment, the appointment may be transmitted from server 14a to one or more systems (e.g., a database, not shown) of service facility 26. Alternatively, a user may directly contact the service facility 26 and make an appointment for a servicing. The user may then service their vehicle at one or more service facilities 26 as in block 72.

It should be readily appreciated that in accordance with the methods of FIG. 2, embodiments of the invention allow a customer to purchase a vehicle directly from a manufacturer without going through a dealer or middleman.

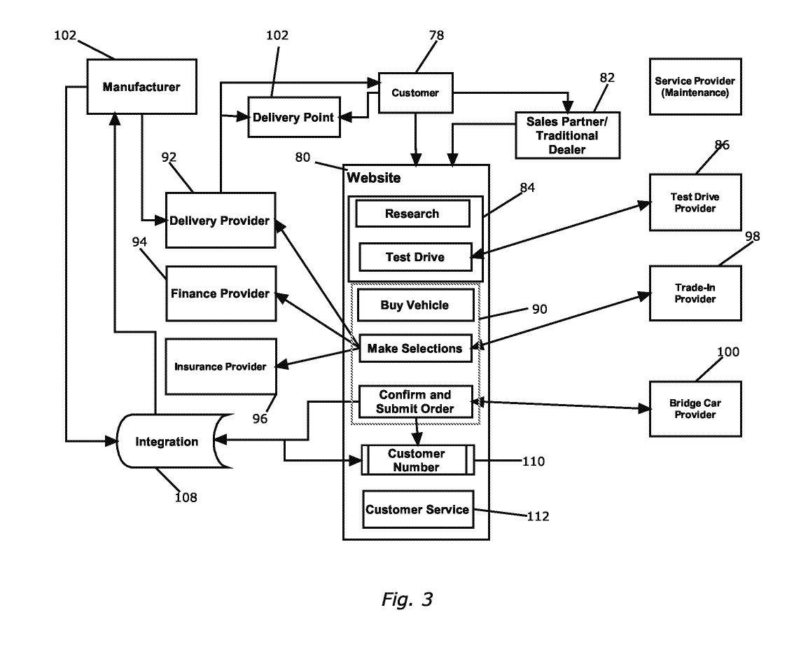

FIGS. 3 to 22 provide various processes in which one or more steps are performed by the System as set forth above. It will be understood that the System includes a computer processor that is operable to perform these steps. In other refinements, a computer medium as set forth above is encoded with instructions for performing these steps. Throughout the description of these processes, the System is described as “prompting” or “querying” the customer. In each instance “prompting” and “querying” will be understood to mean that the server (i.e., computer processor) presents to the customer's terminal a screen displaying information and/or items for selection or input. The customer then interacts with this screen to provide the prompted or queried information.

With reference to FIG. 3, a schematic illustration of interactions during the pre-sale and sale phase of a vehicle purchase is provided. Customer 78 accesses website 80 by either browsing as a guest or by logging-on as a registered customer. Website 80 comprises one or more web pages generated by a server as described in detail above with respect to FIG. 1. Customer 78 is able to access website 80 from virtually any device as set forth above including devices located at a conventional car dealer 82. While accessing website 80, the customer is able to research potential vehicles for purchase (research interface 84) by performing a comparison review of cars within the same class, displaying vehicle specifications, vehicle options, prices, payment simulation, and the like. Customer 78 is also provided financing and insurance options. User selected configuration information is optionally saved for later use. In one refinement, the customer is able to schedule a test drive with test drive provider 86. In a further refinement, the test drive provider is a rental car company or a traditional car dealer with a showroom. In some refinements, test drives are provided as discounted rental cars for extended test drives or as free test drives. For select upscale customer, vehicles may be delivered to the potential customers for test driving. In another variation, customer 78 accesses purchase interface controls 90 which allows the customer to make various selections related to a vehicle purchase. Selections related to purchase interface controls 90 relate to delivery provider 92, finance provider 94, insurance provider 96, trade-in provider 98, and bridge car provider 100. Advantageously, each of providers may separate business entities. In another refinement, a single business entity may provide more than one kind of service. In a refinement, the System maintains a profile for each provider such that additional services can be added to or removed from a provider's profile. Therefore, the customer is always presented with the most current services available. In another refinement, the System allows the service provider to be a separate entity from the delivery agent (in a traditional dealer system, this is not possible)

Still referring to FIG. 3, delivery provider 92 will receive an order vehicle either directly or indirectly from manufacturer 102 and arrange delivery to customer 78 or to a predetermined delivery point 104. Delivery provider 92 typically provides a bill of sale and the documents related to transfer of title. Vehicle orders that have been confirmed and submitted are integrated for submission as indicated by block 108 for submission to manufacturer 102. This latter step allows vehicle orders to be submitted in batches. Moreover, in a particularly useful variation, orders are directly uploaded to the manufacturer's purchases system (i.e., back end integration). In another refinement, the system provides the ability of a customer to have a vehicle build to order (i.e., to the customer's specifications). In a further refinement, the customer directly submits the order to the manufacturer or via the integrated process set forth above. (In return, effective integration includes the manufacturer providing periodic order status reports. Information relating to a vehicle order including order status updates is stored by the server as indicated by block 110. Another feature of the vehicle purchasing system is the availability of online or offline customer service (e.g., phone support), as indicated by block 112. In a refinement, the support is provided by the computer processor being operable to provide online chatting capability between the customer and support personnel.

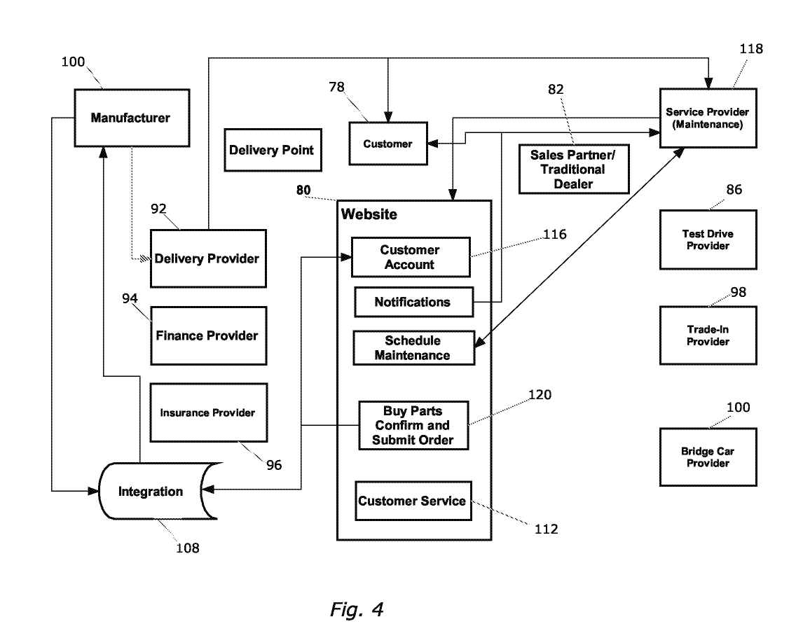

With reference to FIG. 4, a schematic illustration of interactions during the after vehicle phase of a vehicle purchase is provided. Customer 78 during this phase also accesses website 80 to access his account as indicated by block 116. Information that the customer may view includes, but is not limited to, order status and history, warranty and recall information, vehicle service related orders and histories. Similarly, service provider 118 also accesses website 80 in order to view and enter information related to vehicle repairs and service. In one variation, notifications related to scheduled maintenance and/or recalls are automatically sent to the customer. In a refinement, such notifications are also sent to service provider 118. Customer 78 may schedule an appointment via website 80 with service provider 118. In another variation of the present embodiment, customer 78 and/or service provider 118 are able to order vehicle parts through website 80 as indicated by block 120. In such instances, orders are integrated for batch submission to manufacturer 100 (or any identified parts manufacturer or wholesaler) as indicated by block 108. In a refinement, delivery of parts is coordinated through delivery provider 92 for shipment to the customer or service provider 118. A particularly useful feature is the ability of the customer to view the parts order status (related to his vehicle) via website 80 even if parts are ordered by and shipped to service provider 118. Another feature of the vehicle purchasing system is the availability of online or offline customer service as indicated by block 112.

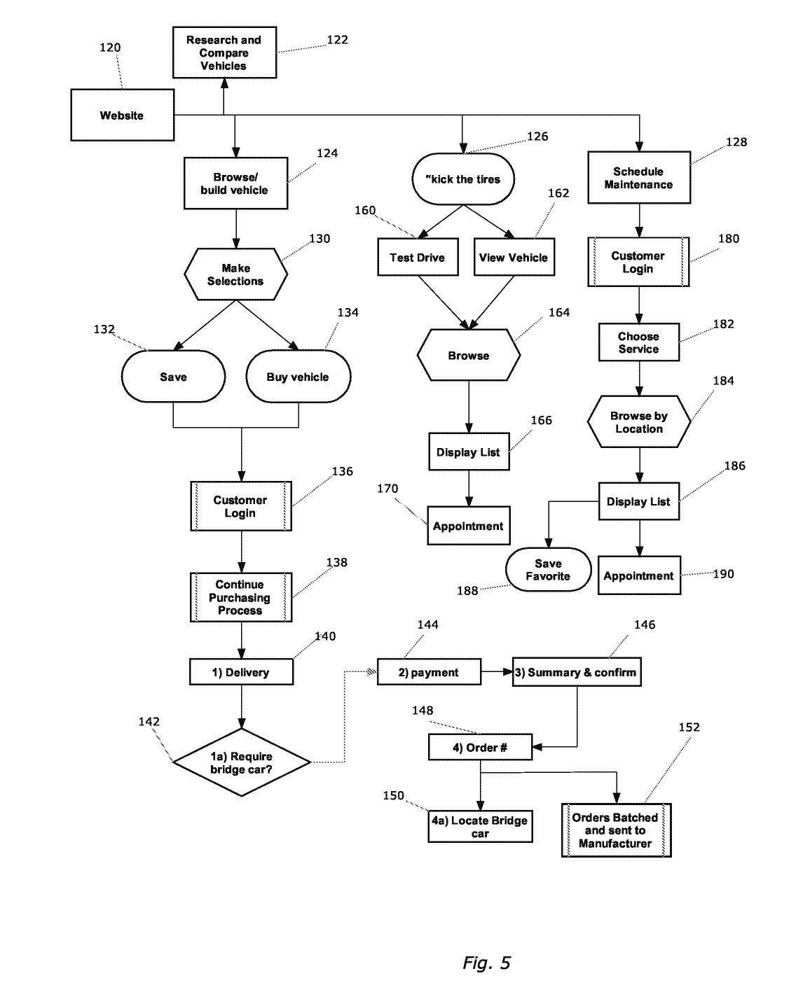

With reference to FIG. 5, a flowchart illustrating the utilization of website 80 depicted in FIGS. 3 and 4 from a customer's perspective is provided. Customers access the website as indicated by block 120. After accessing the website a number of potential paths are provided depending on the customer's objective. The customer may research a vehicle for purchase (block 122), browse/build vehicles (block 124), explore a selected vehicle in detail (block 126), or schedule maintenance (block 128). When a customer pursues the browse/build a vehicle operation, typically selections related to vehicle model and year, option packages, and vehicle color are made as indicated by block 130. The website provides that summary information related to the customer's selection be displayed upon request. Selections may be saved for later use (block 132) or the customer may proceed to perfect the purchase (block 134). Up to this point, it is not necessary for the customer to have logged in. However, in order to complete a purchase, the customer must login (block 136) so that certain identifying information can be associated with the purchase. After login, the purchasing process continues (block 138) with the customer selecting the delivery options (block 140). As depicted in block 142, the customer indicates whether or not a bridge vehicle is desired. In a refinement, the bridge vehicle will be the same model as the ordered vehicle. The website also provides for the entry and selection of the payment options (block 144). For example, provision may be made for making a down payment (e.g. credit card, debit card, wire transfer, PayPal, and the like). In a refinement, the down payment will be non-refundable. During this step, arrangements for setting up financing and/or making payment are provided. Payment methods that are acceptable include, but are not limited to, debit cards, credit cards, bank transfers, checking account transfers, PayPal, private loans). During the payment step, information related to trade-in value is also provided. Typically, this step will also allow for the inputting of proof of insurance. After the particulars related to payment have been provided at the website, typically the information to that point will be summarized and displayed for review (block 146). The summary will include the vehicle/options chosen, the cost, the delivery location, and the estimated delivery date. An order number is provided with a confirmatory email summarizing the purchase (block 148). Emails or other methods of surveying customer feedback may also be sent at this time. Such surveying provides a customer rating/comment system regarding service providers to encourage positive competition and the ability to naturally eliminate lower quality providers through poor ratings (i.e., fewer customers will choose them). In a refinement, delivery agents with a poor rating choose on their own not to renew their license to participate in the System. If a bridge car had been requested, it is typically located at this time (block 150). Finally, after financing has been confirmed, the orders are batched for sending to the vehicle manufacturer (block 152).

Still referring to FIG. 5, prior to purchase, the customer may desire to engage in a more in depth evaluation of a particular vehicle model (block 126). This aspect of the present embodiment is fulfilled in one instance by providing for a test drive (block 160). In addition, provisions allowing the customer to view a vehicle at a dealer's show room or any pre-established viewing site are provided (block 162). In either of these scenarios, the customer is allowed to browse on the website vehicles that are available for test driving or viewing (block 164). Upon appropriate selection by the customer, a list identifying the locations and relate names for the vehicles to be viewed or test driven are then provided (block 164). Mapping information to these locations may also be provided at this time using a service such as Google™ Maps. Finally, an appointment for viewing and/or test driving is made at the website (block 166).

Still referring to FIG. 5, after purchase, the customer may schedule maintenance or service for his vehicle at the website (block 128). In this scenario, the customer logs in at the website (block 180) and chooses the type of service required (block 182). The System provides a list of maintenance providers to the customer. The customer may then browse locations that are capable of providing such services (block 184). In a refinement, each maintenance provider is a business partner authorized to provide warranty service. This refinement allows the customer to receive warranty work at a place of their choosing, versus only at a dealership. In a refinement, any favorite service facilities that have been previously identified will be defaulted to. Selected service facilities along with their addresses are displayed by the System (block 186). As set forth above, map information to a location may also be provided at this time. Listed facilities may be designated as favorites at this time (block 188). Finally, an appointment for service is made (block 190). Typically, the customer is presented with a calendar listing available open dates and times for service.

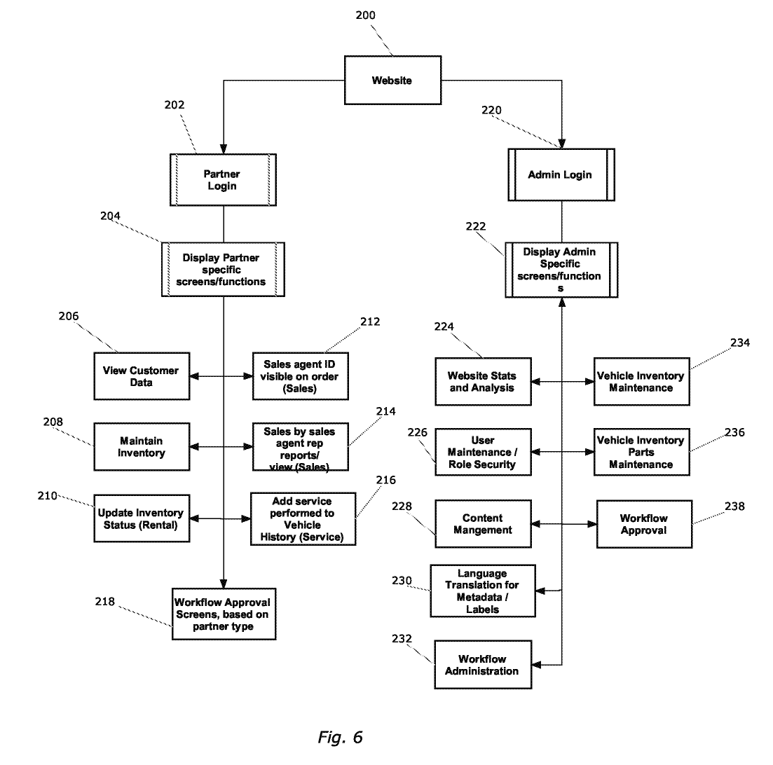

With reference to FIG. 6, a flowchart depicting utilization of the website depicted in FIGS. 3 and 4 from a business partner and administrator perspective is provided. In the context of the present embodiment, a business partner is one of test drive provider 86, delivery provider 92, finance provider 94, insurance provider 96, trade-in provider 98, bridge car provider 100, and manufacturer 102. Business partners access the website (block 200) and then login as depicted in block 202. After login, specific screens related to the service provided by the business partner are provided (block 204). Examples of information and functions available to a particular business partner include, but are not limited to, customer data such as customer specific details, vehicle data and history, and warranty info (block 206), available parts and vehicle inventory (block 208), rental inventory status (block 210), sales agent identifier for an order (block 212), sales reports (214), and service history (block 216). In a refinement, business partner specific workflow approval screens are provided to the business partner at the website (block 218). Examples of such workflow approval screens include, but are not limited to, credit check and approval, final payment approval, insurance policy info confirmation, updating and confirming trade-in value, and appointment scheduling.

Still referring to FIG. 6, an administrator accesses the website (block 200) and then logs in (block 220). At this point, the administrator is then presented with administrator specific screen(s) providing for various administrator specific functions. The functions provided can be broken down into pure administrative functions and business promoting functions. Examples of the administrative functions include, but are not limited to, viewing and analyzing website statistics (block 224), user maintenance/role security (block 226), content management, language translation for metadata/labels (block 228), and workflow administration (block 230). Examples of business functions include but are not limited to, vehicle inventory maintenance (block 232), vehicle inventory parts maintenance (block 234), and workflow approval (block 236).

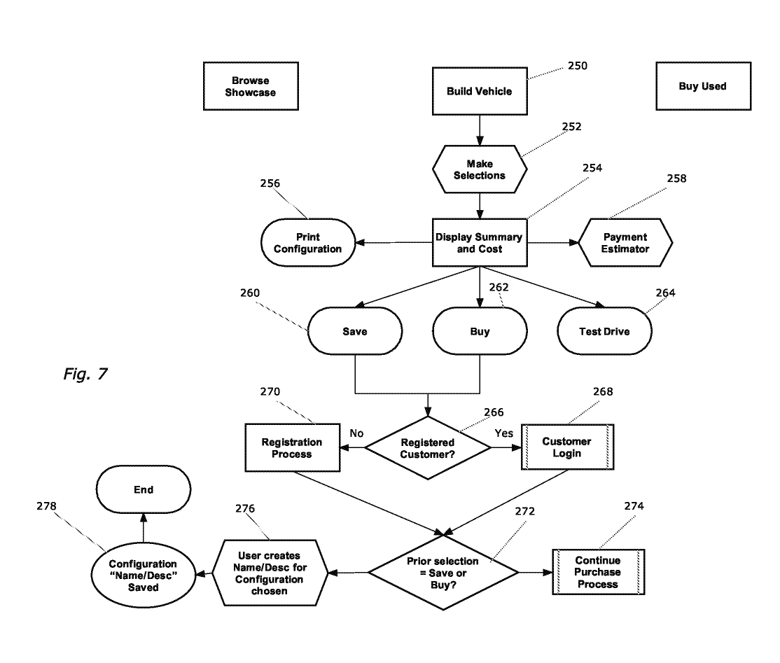

With reference to FIG. 7, a flowchart depicting the step by which a customer initiates the building of a vehicle is provided. The inputs to this sequence of steps are initiated by the customer browsing or selecting build from the website set forth in FIG. 3. The output of these steps is a saved configuration or a decision to purchase a vehicle. After accessing the website, the customer initiates a vehicle build as set forth in block 250. The customer makes relevant selections related to the vehicle to be built (block 252). Examples of relevant selections include vehicle model and year, packages, options, vehicle color, and the like. After the selections are made, the System displays a summary along with the cost of the specified vehicle (block 254). At this point, the customer may optionally print a summary of the vehicle configuration (block 256) and price and/or access a payment estimator for determining monthly payments (block 258). In the next step, the customer may save the information related to the vehicle assembled thus far (block 260), buy the vehicle (block 262), and/or request a test drive (block 264). As depicted in block 266, the customer is asked if they are a registered customer. If the customer is a registered user, a logon screen is presented to the customer (block 268). If the customer is not a registered user, a form is presented with which the customer may register (block 270). The customer then decides whether to purchase the vehicle or to save the purchase information (block 272). If the decision is made to perfect the purchase, the purchase process proceeds (block 274). If the customer decides to save the information, an identifying name or description for the vehicle configuration is solicited and received from the customer (block 276). This name/description is then saved by the server (block 276).

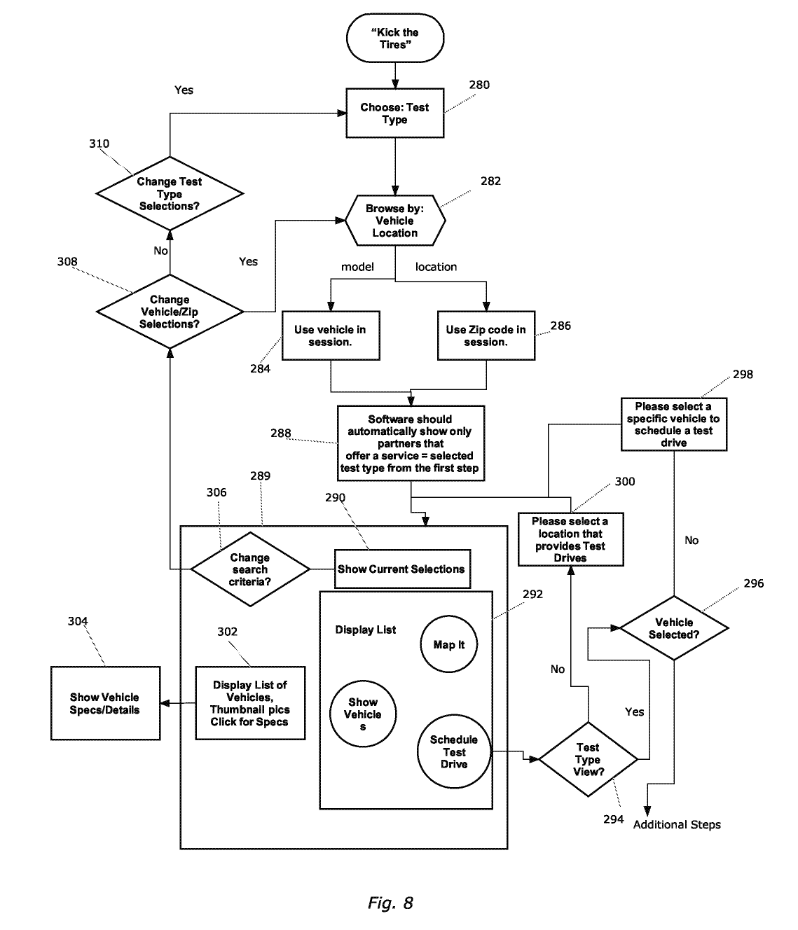

With reference to FIG. 8, a flowchart illustrating the implementation of a “kick the tires” functionality is provided. The “kick the tires” functionality is a vehicle testing provision that provides the ability of the System to offer a test drive experience as well as more in depth viewing of a vehicle. In the step depicted by block 280, the System presents a set of available test types to be chosen by the customer. Examples of vehicle test types include free test drives accompanied by an agent, extended test drives, or a vehicle viewing each of which involves the participation of a business partner. Typically, an agent will accompany the customer during the free test drive. In the extended test drive, the vehicle is checked out by the customer with an optional fee collected. Typically, an agent will logon to the System to schedule an extended test drive. A vehicle viewing is done in person at any number of predetermined locations (local showroom in malls, dealerships). After one or more test type options are chosen, a browser screen is presented to the customer listing available vehicles for the test (block 282). Browsing is either by vehicles at a selected location or by locations having a selected vehicle type. In one instance, the System uses the previously selected vehicle (block 284). If there isn't any such vehicle or if a change is requested, the vehicle selection process is restarted. In another instance, a zip code or other location identifier is used to find vehicles by location (block 286). If there is no such selection, the customer is prompted to enter one. If there is no such vehicle or if a change is requested, the vehicle selection process is restarted. In a refinement, the System only displays partners that offer the service selected by the customer (block 288). The System enters an implementation phase at this point as depicted by block 289. The selections up to this point are then displayed (block 290). Relevant information about the service providers (e.g., name, address, contact info, phone number, email, services provided) is displayed (block 292). Mapping information to the service provider locations may also be provided at this time using a service such as Google™ Maps. At this point, a test drive may be scheduled either by vehicle type or by location (block 294). If the customer desires to test drive a particular vehicle model, the System determines whether or not a selection has been made for a vehicle type to be test driven (block 296), if not the customer is queried to make such a selection (block 298). If the customer desires to have a test drive at a particular location, the System determines whether or not a location has been selected (block 300). As depicted by block 302, the System is operable to display a list of vehicles, thumbnail pics, etc. The customer, when presented with such a list, will “click” a suitably displayed hyperlink to view a vehicle specification (block 304). The customer is also provided with the opportunity to change the search criteria (block 306). If a change is desired, the System queries the customer if they would like to change the vehicle type or location (block 308) or if the type of test is to be changed (block 310).

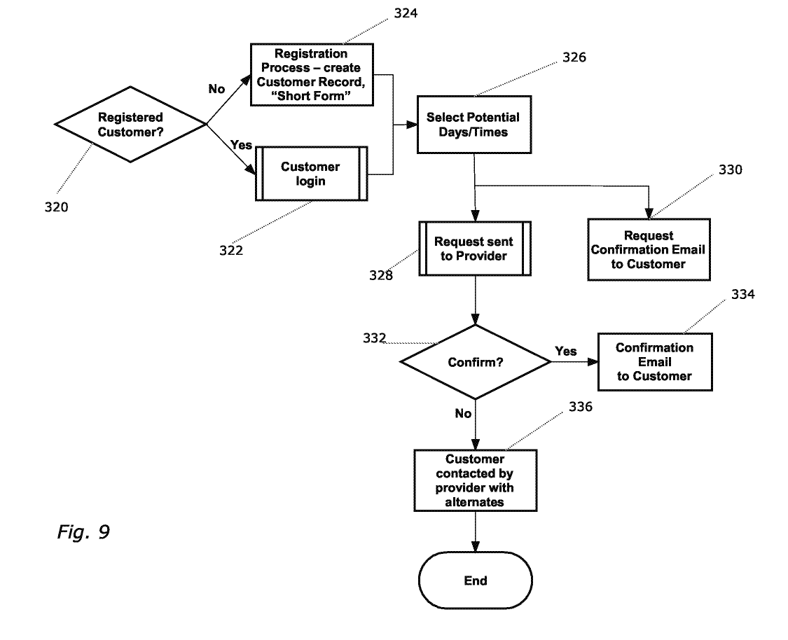

With reference to FIG. 9, a flowchart illustrating steps for scheduling a test drive is provided. As set forth in block 320, the System queries the customer to indicate if they are a registered user. If the customer is a registered user, the customer logs on (block 322). If the customer is not a registered user, the customer is provided suitable screens in order to register and then logs on (block 324). The customer then selects potential dates and times for the test drive (block 326). The System then sends the test drive request to the test drive provider (block 328). In a refinement, a confirmation email is sent to the customer (block 330). The System then determines whether or not one of the requested dates is acceptable to the provider (block 332). If the timing is acceptable, a confirmation email is sent to the customer (block 334). If the dates are not acceptable, the provider provides alternative dates to the client via mediation by the System (block 336).

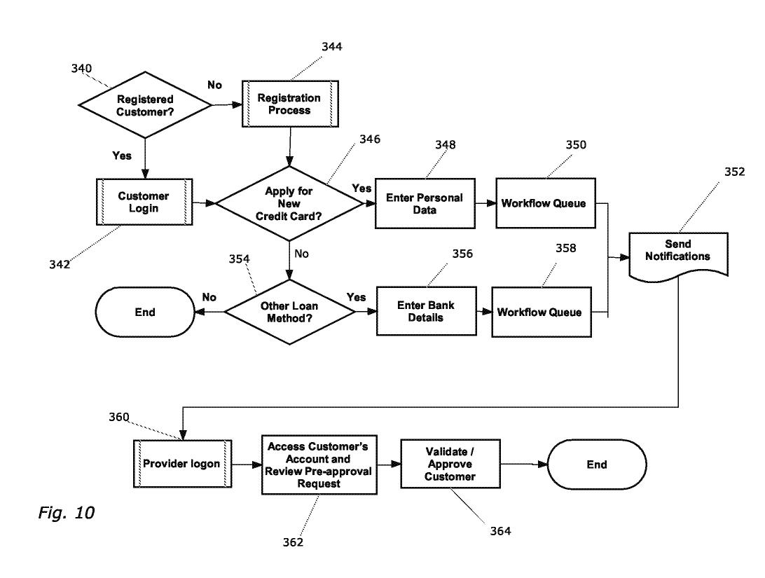

With reference to FIG. 10, a flowchart illustrating steps for pre-approving a customer for a vehicle purchase is provided. As set forth in block 340, the System queries the customer to indicate if they are a registered user. If the customer is a registered user, the customer logs on (block 342). If the customer is not a registered user, the customer is provided suitable screens in order to register and then logs on (block 344). In each instance, after the customer logs on, the System invites the customer to apply for a new credit card. If the customer enters an affirmative response to the query, the System presents an online application form for the customer to enter personal data. The application form is then submitted to a financial partner's workflow queue for subsequent processing (block 350). Notifications of the pending application are then sent to the financial provider (block 352). If the customer does not desire to apply for a credit card, then the System queries the customer if there is alternative financing (block 354). If there is no alternative financing, the process terminates. If there is alternative financing, the customer is presented with suitable online forms to enter the relevant financing information (block 356). The application form is then submitted to a financial partner's workflow queue for subsequent processing (block 358). Notifications of the pending application are then sent to the financial provider (block 352). As depicted in block 360, the financial partner, after receiving a notification, logs onto the System and then uses the System to access the customer's account (block 362). The provider reviews the application for potential pre-approval. The provider then enters into the System a determination as to whether or not pre-approval is granted.

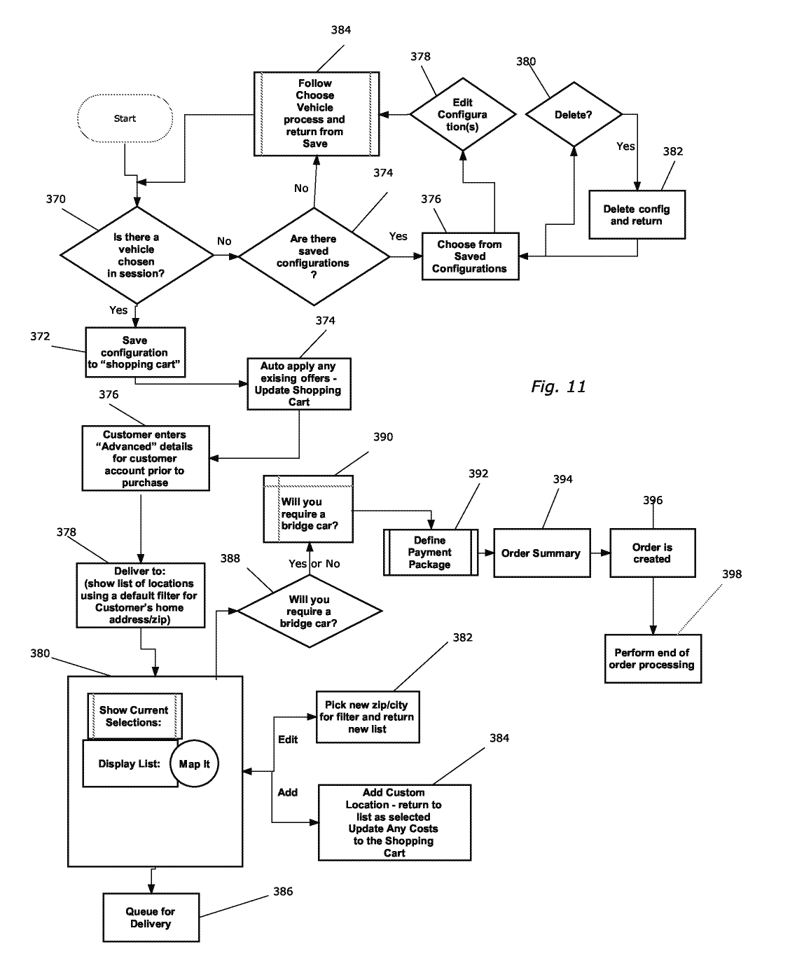

With reference to FIG. 11, a flowchart illustrating the steps for purchasing a vehicle is provided. As depicted in block 370, the System determines whether or not a vehicle has been selected during an online session. If a selection has been made, the selected vehicle configuration is saved to an online shopping cart (block 372). If a selection has not been made, the System determines if there are any saved vehicle configurations (block 374). If there are saved configurations, the System prompts the customer to select one of the saved configurations (block 376). In a refinement, the System prompts the customer to edit (block 378) or delete (blocks 380 and 382). The System, as set forth in block 384, directs the user back to steps depicted in block 370 for choosing a vehicle. In either instance, after a vehicle configuration has been saved to the shopping cart, the System automatically applies any existing offers/discounts and then updates the shopping cart (block 374). The System then prompts the customer to enter advanced details for the customer account prior to purchase (block 376). The System then queries the customer to selected options for delivery (block 378). In a refinement, the System shows a list of locations using a default filter for the customer's home address/zip. As depicted in block 380, a summary of the selections related to the vehicle is displayed by the System. Relevant information about the delivery providers (e.g., name, address, contact info, phone number, email, services provided) is displayed. Mapping information to the delivery provider locations may also be provided at this time using a service such as Google™ Maps. The addresses for the customer may be edited (block 382) or a new address added (block 384) at this time. The relevant purchase information is then queued to the delivery partner (block 386). The delivery partner is also notified of the pending purchase. As set forth in block 388, the System queries the customer whether or not a bridge vehicle is required (block 388). The answer to this query is stored (block 390). The System determines the applicable payment options in block 392. The System provides a summary and prompts the customer to confirm the order (block 394). The System then creates an order with an associated order number (block 396). Finally, the System executes an end of order process in which a confirmation email containing the order number and purchase details is sent to the customer (block 398). A survey is presented to the customer to evaluate the process and providers that had participated in the purchasing process. In one refinement, the survey is sent via email. The survey allows the various providers to be ranked so that under performing provider may be dropped from the System, if desired.

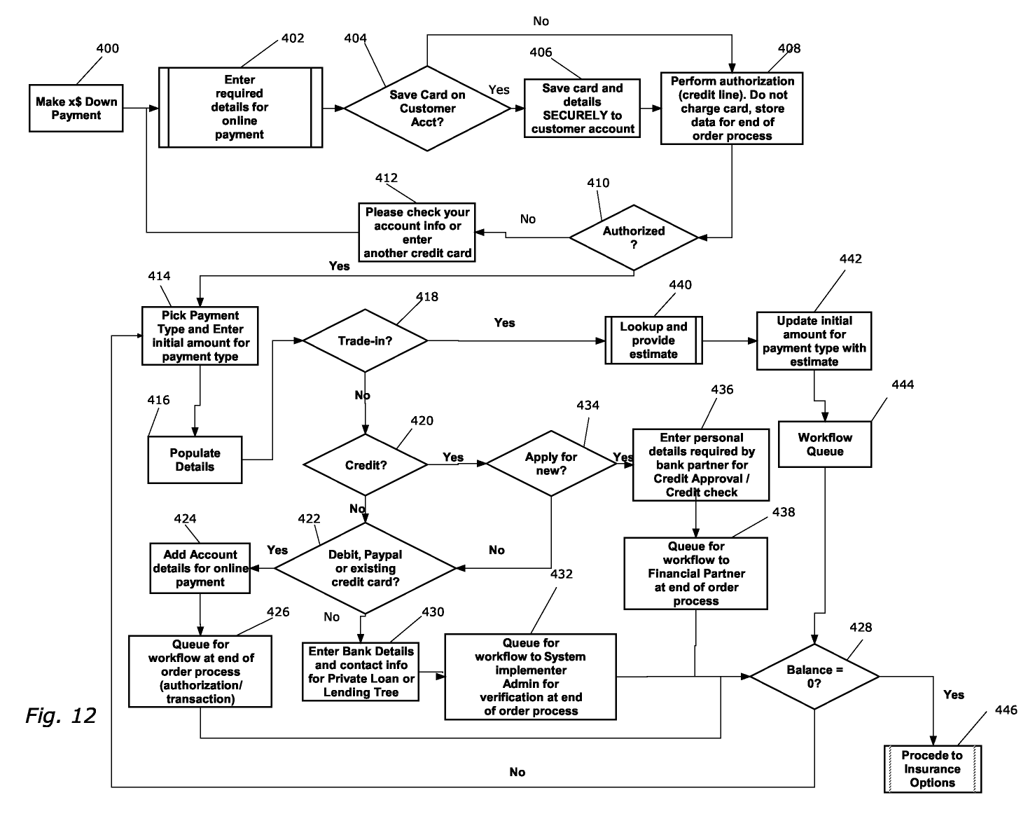

With reference to FIG. 12, a flowchart illustrating steps for defining a payment plan for the vehicle purchase is provided. As depicted by block 400, the System prompts the user to enter information for making a down payment. The System provides an entry screen for the customer to enter details for making an online payment (block 402). The System then prompts the customer to specify whether or not they want to save credit card information (block 404). If the customer enters an affirmative response, then the information is saved to the customer's account records (block 406). The System then performs an authorization check for the vehicle order (e.g., credit line verified) (block 408). Typically, the card is not charged but the data is saved for an end of order process. If the customer opted not to have the credit card information saved, the process jumps directly to the steps of block 408. The System checks to see if the credit card has been authorized (block 410). If authorization failed, the System requests that the customer enter alternative credit card/line information (block 412). If the credit is authorized, the System prompts the customer to pick a payment type and to enter an initial amount for the payment type (block 414). Examples of payment types include trade-in, debit card, credit card, PayPal, a private loan, Lending Tree and the like. If the loan has been preapproved, the System presents the customer with a screen with information from the customer account (e.g., confirmed value, updated to confirmed balance) (block 416). The System then queries the customer as to whether or not there will be a trade-in vehicle (block 418). If there is no trade-in vehicle, the System then queries the customer to find out if credit will be applied for (420). If credit if not to be applied for, the System queries the customer if he will be using an online payment such as a debit card, Paypal, or an existing credit card (block 422). If the customer responds affirmatively, the System prompts the user to enter the account details for an online payment (block 424). The System then places the details for the transaction onto workflow queue (block 426). The System then makes a determination as to whether or not the remaining balance to be paid is zero (block 428). If the customer is not going to use an online payment method such as a debit card, Paypal, or an existing credit card, the System prompts the customer to enter bank details and contact information for a private loan or Lending Tree (block 430). The System then places the payment details on a workflow queue (block 432). The System then makes a determination as to whether or not the remaining balance to be paid is zero (block 428). With respect to block 420, if a customer desires to apply for credit, the System proceeds to the steps of block 434 in which the customer is queried to apply for new credit (block 434). If the customer decides not to apply for credit, the System implements the step of block 422 as set forth above. If the customer desires to apply for new credit, the System queries the customer to enter personal details required by the bank partner for credit approval /credit check (block 436). The System then places the details for the credit application on a workflow queue for the financial partner (block 436). The System then makes a determination as to whether or not the remaining balance to be paid is zero (block 428). With respect to block 418, if the customer indicates that there is a trade-in vehicle, the System looks up the trade-in vehicle and provides an estimate of the value (block 440). The System then updates the initial amount for the payment type with the estimate of the trade-in value (block 442). The System again makes a determination as to whether or not the remaining balance to be paid is zero (block 428). With respect to block 428, if the outstanding balance for the vehicle purchase is not zero, the System returns to the steps of block 414. If the balance is zero, the System proceeds to implement the steps associated with choosing the vehicle insurance options (block 446).

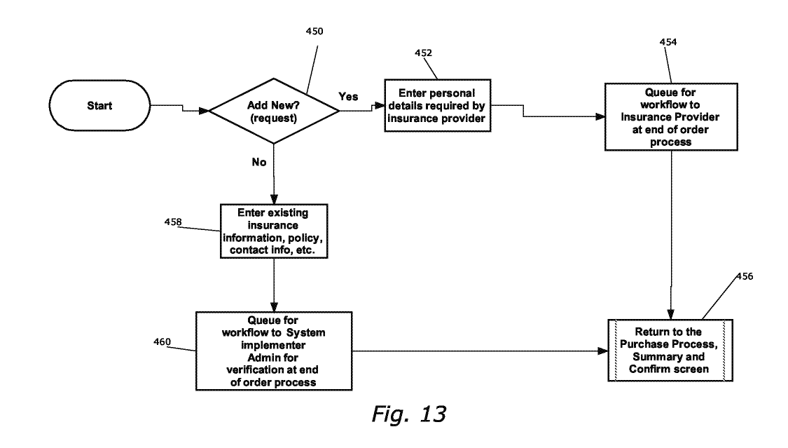

With respect to FIG. 13, a flowchart illustrating the steps related to providing proof of insurance to the purchase vehicle is provided. As set forth in block 450, the System queries the customer if they need to apply for new insurance or if there is already a policy in place. If the customer indicates that a new policy is to be applied for, the System prompts the customer to enter the personal details required by the insurance provider (block 452). The System then places the details for the insurance application on a workflow queue to be directed to the insurance provider (block 454). The System then returns to the purchase process and provides a summary and confirm screen (block 456). If there is an existing policy, the System prompts the customer to enter the information about this policy (block 458). The System then places the details for the insurance application on a workflow queue to be directed to the insurance provider (block 460). The System then returns to the purchase process and provides a summary and confirm screen (block 456).

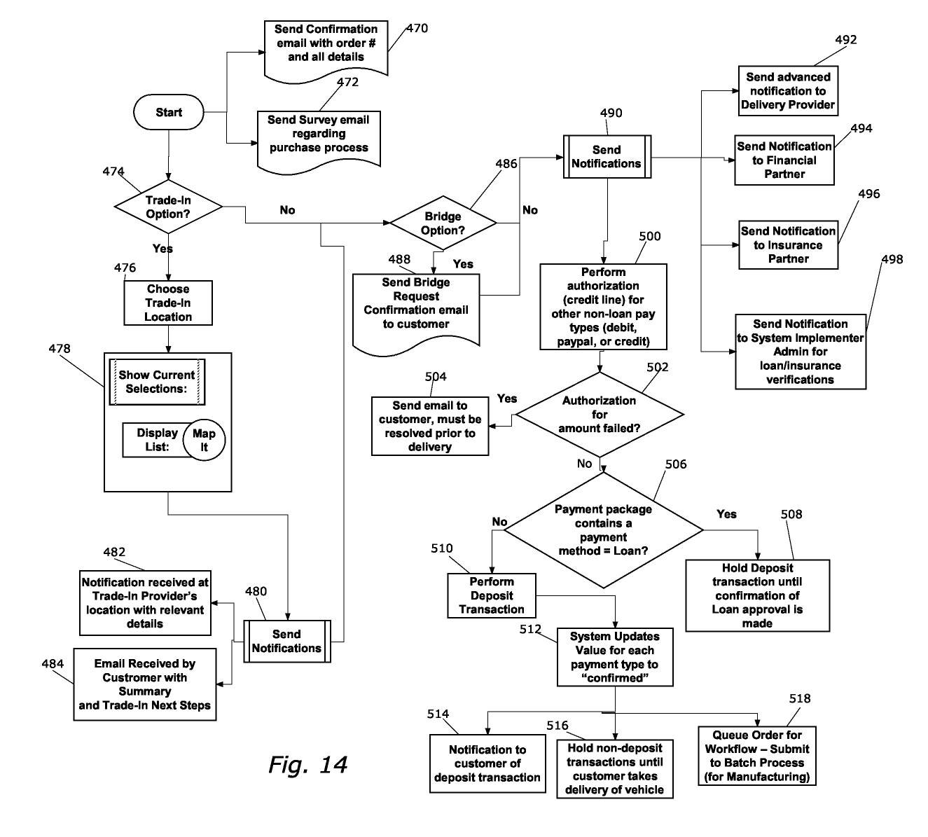

With reference to FIG. 14, a flowchart illustrating the end of vehicle order process is provided. The System sends a confirmation email with the order number and the details of the vehicle purchase (block 470). In a refinement, a survey email is sent to provide customer feedback about the purchasing process and about the business partners (e.g., service provider) (block 472). Service providers receiving a low rating may opt to voluntary drop out of the online vehicle purchasing system or may be involuntary dropped. As depicted in block 474 the System determines whether or not the trade-in option was utilized. If the trade-in option is not used, the System proceeds to the steps related to block 486. If the trade-in option was used, the System prompts the customer to select trade-in location (block 476). The System shows a list of locations using a default filter for the customer's home address/zip. The System then shows the selection for the trade-in location (block 478). The System also displays the name, address, and contact information for the trade-in location. Mapping information to these locations may also be provided at this time using a service such as Google™ Maps. As set forth in block 480, the System sends out relevant email notification regarding the trade-in. A notification is sent to and received by the trade-in provider (block 482). An email is also sent to the customer with a summary regarding the trade-in and instructions for the next steps to be followed. The System then proceeds to the steps related to block 486. If the trade-in option was not used, the System determines if a bridge vehicle was requested (block 486). If a bridge option was requested, a bridge request confirmation email is sent to the customer (block 488). The System then proceeds to send notifications as depicted in block 490. If a bridge option was not selected, the System proceeds directly to the steps of block 490. With respect to block 490, the following notifications are sent—advanced notification to delivery provider (block 492), notification to financial partner (block 494), notification to insurance provider (block 496), and notification to system implementer administrator for loan/insurance verifications (block 498). The system implementer is the entity that is responsible for maintaining/administering the System. The System then performs authorization checks (credit line) for other non-loan pay types (debit, Paypal, or credit) (block 492). The System checks to see if the authorization has failed (block 502). If the authorization failed, an email is sent requesting that the payment be resolved (block 504). In a refinement, the email provides a link back to the payment process so that the customer may try again. If the authorization succeeds, the System determines if the payment package includes a loan (block 506). If the package does include a loan, the deposit is held until confirmation of the loan approval is received (block 508). If there is no loan, a deposit transaction is performed (block 510). The System then designates each payment type as confirmed (block 512). The System then sends a notification to the customer of the deposit transaction (block 514). Non-deposit transactions are held until the customer takes delivery of the vehicle (block 516). The order is placed on the workflow queue for the manufacturer (block 518).

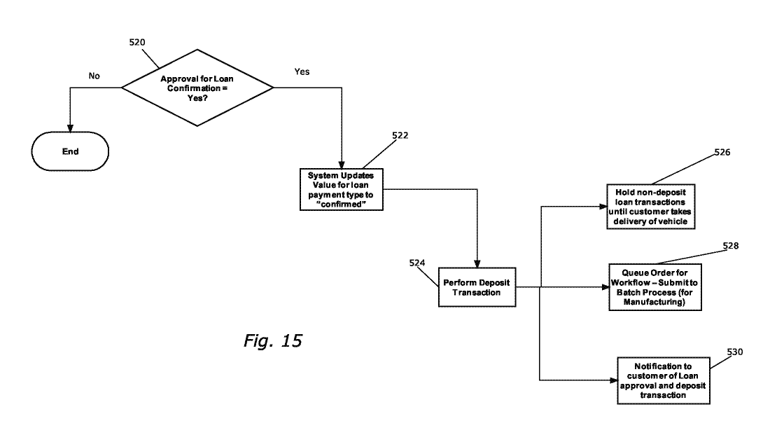

With reference to FIG. 15, a flowchart illustrating the steps for a vehicle loan approval is provided. The System determines if the loan was approved (block 520). If not, the process terminates. If the loan is confirmed, the System changes the value for the loan payment type to confirmed (block 522). The System then performs a deposit transaction (block 524). Non-deposit loan transactions are held until the customer takes delivery (block 526). The order is place on a workflow queue for the manufacturer (block 528). The System sends a notification to the customer about the loan approval and the deposit transaction.

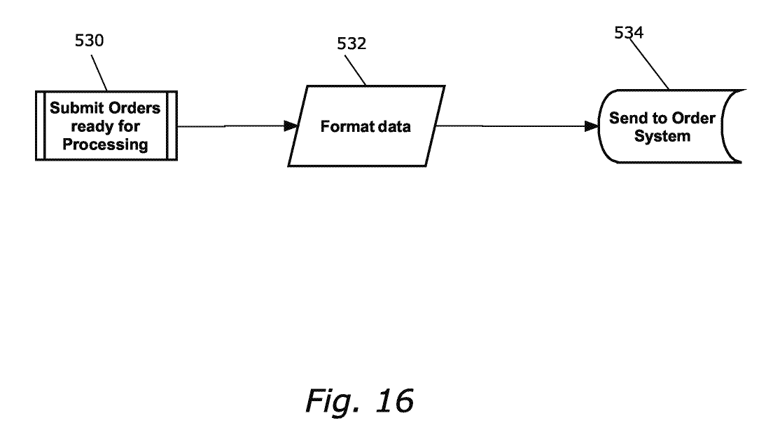

With reference to FIG. 16, a flowchart illustrating the steps involved in batching vehicle orders to the vehicle manufacturer is provided. The orders are provided to the manufacturer as queued workflows. The System submits orders for processing (block 530). The System formats the order data (block 532). The System sends the orders to the manufacturer's order system (block 534).

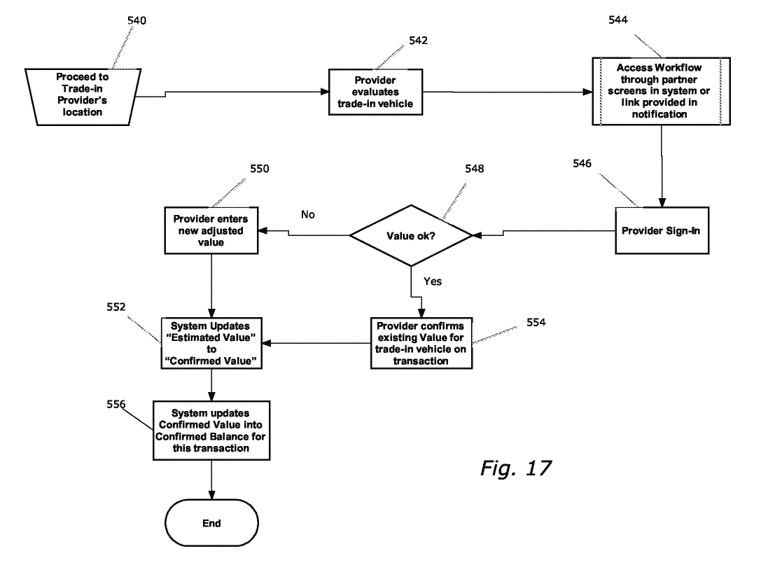

With reference to FIG. 17, a flowchart illustrating the steps involved in the trade-in process is provided. The customer proceeds to the trade-in provider's location (block 540). The trade-in provider evaluates the trade-in vehicle (block 542). The trade-in provider accesses the workflow through partner screens provided by the System or a link provided by a notification (blocks 544 and 546). The provider determines whether or not the trade-in value already in the System is acceptable (block 548). If the value is acceptable, the trade-in provider confirms the value (block 550). If the value is not acceptable, the provider enters a new adjusted value (block 556). In both cases, the System updates the trade-in value designation from “estimated value” to “confirmed value” (block 552). The System then updates the confirmed value for this transaction.

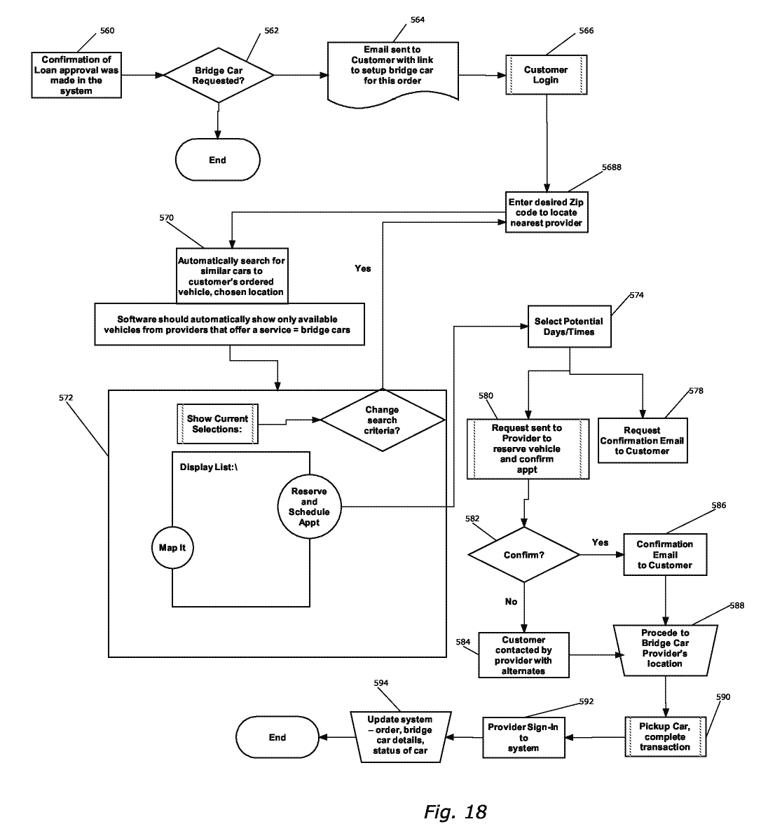

With reference to FIG. 18, a flowchart illustrating the steps implemented of the System in fulfilling a bridge vehicle request is provided. In one refinement, the bridge car is a short term lease for a vehicle that is similar to the purchased vehicle during the waiting period. As depicted in blocks 560 and 562, the System determines if a bridge vehicle was requested. If a vehicle was not requested, the process ends. If a bridge vehicle was requested, the System emails the client a notification with a link to setup the bridge vehicle for the order (block 564). Upon receiving the email, the customer logs on to the System (block 566). The System prompts the customer to enter a zip code so that the nearest bridge car provider is located (block 568). The System automatically searches for similar vehicles to the vehicle ordered by the customer at location near the entered zip code (block 570). Typically, the System will only show available vehicles from providers that offer bridge cars. The System then shows a summary of the current selections (block 572). At this time, the System displays the provider's name, address, and contact information. Mapping information to these locations may also be provided at this time using a service such as Google™ Maps. In a refinement, the search criteria may be changed with the System looping back to the steps of block 568. Typically, the System will prompt both the provider and the client form information so that an appointment may be scheduled. As depicted in block 574, the System prompts the customer to select potential days and times to pick up the bridge vehicle. A request confirmation email is then sent to the customer (block 578). The System sends a request to the trade-in provider to reserve a vehicle and to confirm the appointment (580). The System receives a response from the provider and checks to see if the appointment is confirmed (block 582). If the appointment is not confirmed, the trade-in provider contacts the customer to make alternative arrangements (block 584). If the appointment is confirmed, a confirmation email is sent to the customer (block 586). In both instances, the customer will proceed to the bridge vehicle provider's location (block 588). The vehicle is picked up and the transaction is completed (block 590). The trade-in provider signs into the System to enter details about the completed bridge car transaction (block 592). The System updates the order details and status of the bridge vehicle (block 594).

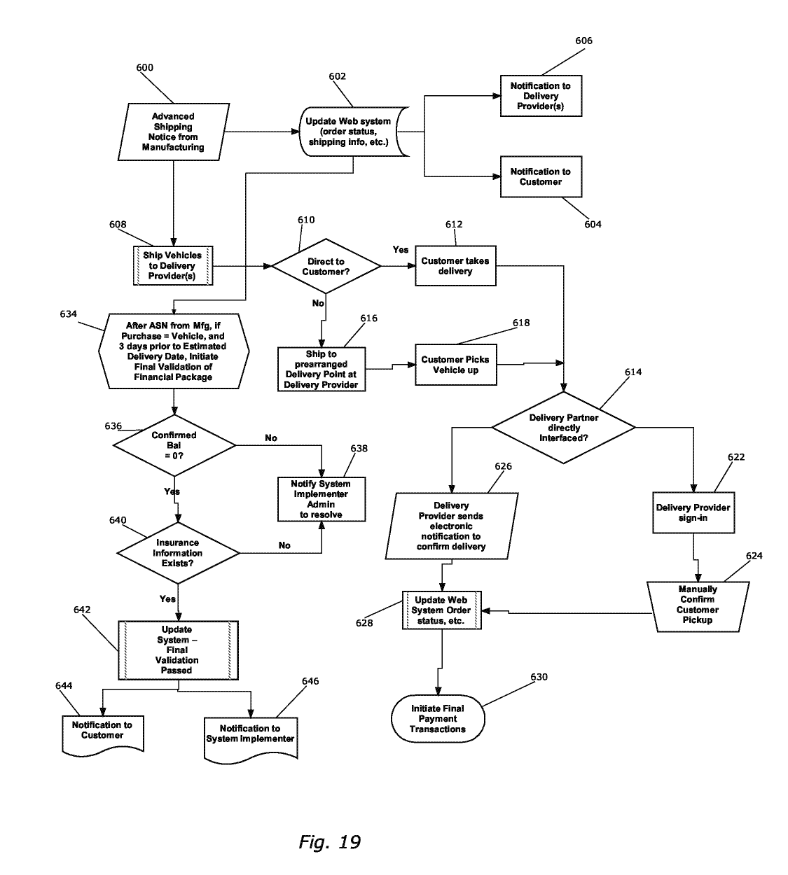

With respect to FIG. 19, a flowchart illustrating the steps for vehicle or part delivery in accordance with an embodiment of the invention is provided. The System receives a notification from the manufacturer that the item is ready to be shipped (part or vehicle) (block 600). The System is updated (block 602) with notification sent to the delivery provider (block 604) and to the customer (block 606). Advantageously, certain embodiments of the invention allow the delivery provider to be a separate entity from the manufacturer and/or vehicle dealer. The items are then shipped to the delivery provider (block 608). The System then determines from the order details if the item is to be directly shipped to the customer (610). If the item is to be shipped directly to the customer, the customer then takes the delivery (block 612). The System then proceeds to implement the steps of block 614. If the item is not to be directly shipped to the customer, the item is shipped to a prearranged delivery point at the delivery provider (block 616). The customer then pick up the item (block 618). The System then proceeds to the steps of block 614. With respect to block 614, the System determines if the delivery provider is directly interfaced. If not, the delivery provider is prompted to log on (block 622). The delivery provider then manually confirms the customer pickup (block 624). If the provider is directly interfaced, the provider sends an electronic notification to confirm delivery (block 626). The order status is then updated by the System (block 628). The system then initiates the final payment transaction (block 630). Referring now to the steps of block 632 which is also implemented after the steps of block 602, the System initiates a final validation of the financial package (block 634). The System determines if the balance is now zero (block 636). If the balance is not zero, the System notifies the system implementer administrators to resolve (block 638). If the balance is zero, the System verifies that the vehicle has insurance coverage (block 640). The System then updates the purchase details (block 642). The System sends notifications to the customer (block 644) and to system implementer (block 646).

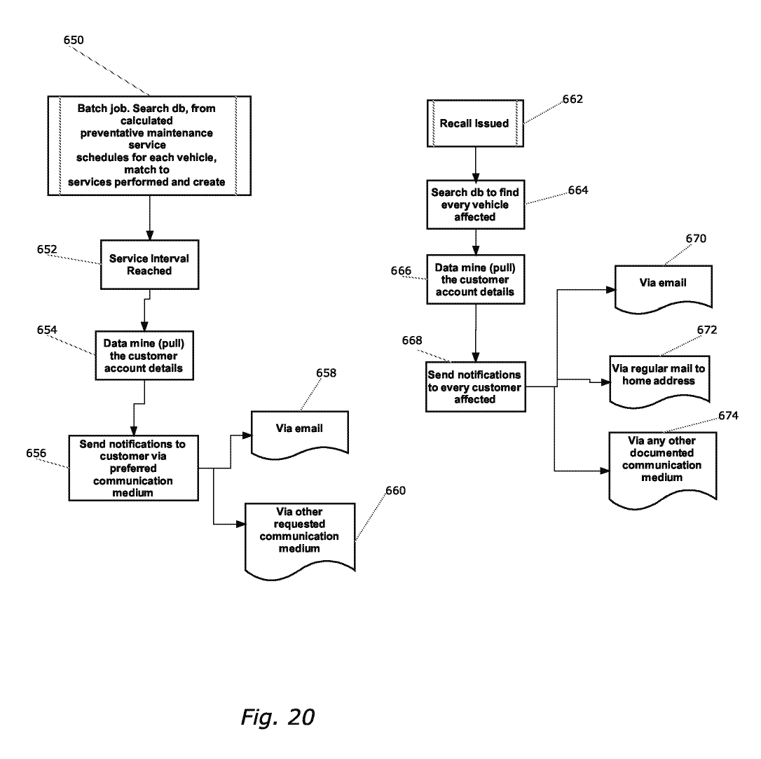

With reference to FIG. 20, flowcharts illustrating the steps involved in the System sending maintenance notifications are provided. Typically, notifications are sent after a predetermined period of time, after a predetermined mileage, or for a recall. As depicted in block 650, a database (db) is search for vehicles in which there are discrepancies between the services performed and the calculated preventive maintenance service schedules. The System determines if a service interval has been reached (block 652). If so, the System retrieves the customer account details (block 654). The System sends a notification to the customer utilizing a preferred communication medium (block 656). Notifications typically include the service needed and attendant details as well as a link to schedule maintenance at the website. Such notification may be sent by email (block 658) or by any other customer requested medium (block 660). With reference to block 662, the System receives a notice that a recall is to be implemented. The System searches a customer database to find vehicles affected by the recall (block 664). The System gathers the customer account details for the recall (block 666). The System sends notifications to the customers having affected vehicles. The notifications typically include the recall details and related information and a link to schedule maintenance/repair on the website (block 668). Notifications may be sent by email (block 670), regular mail (block 672), or by any other customer requested medium (block 674).

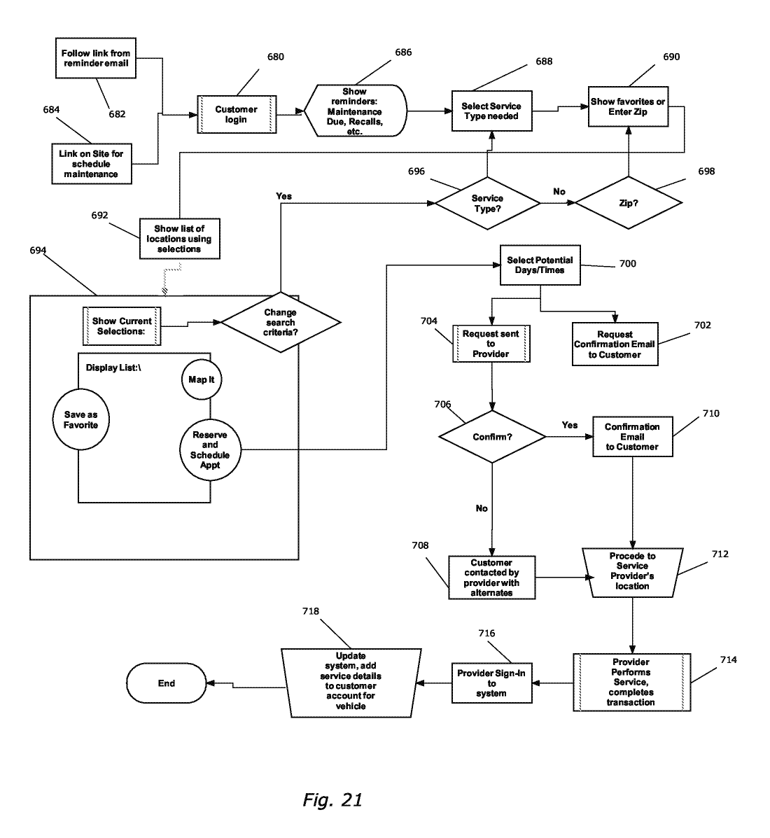

With reference to FIG. 21, a flowchart illustrating the steps involved in scheduling maintenance is provided. A customer logs onto the System as depicted by block 680. The customer arrives at a login screen by either following a link from an email reminder (block 682) or by following a link on a system related website (block 684). After the customer logs on, the System displays reminders for the maintenance due and for any relevant recalls (block 686). The user is then prompted to select the service type needed (block 688). The System then displays to the customer a listing of any favorite maintenance providers that have been previously identified (block 690). The customer is also provided with the ability to enter a zip code or other location identifier so that nearby providers may identified. The System then shows a listing of locations offering the required service (block 692). The System will then show a summary of the current selections including service type and location identifier. A listing of the providers which includes the name and address of the provider as well as the contact information is provided by the System (block 694). Mapping information to these locations may also be provided at this time using a service such as Google™ Maps. The customer is given the option to change the service type (block 696) or the provider location (block 698). The System prompts the customer to select potential days and times for the maintenance/repair (block 700). A confirmation email is then sent to the customer (block 702). The System sends a request to the maintenance provider to schedule the appointment (704). The System receives a response from the provider and checks to see if the appointment is confirmed (block 706). If the appointment is not confirmed, the maintenance provider contacts the customer to make alternative arrangements (block 708). If the appointment is confirmed, a confirmation email is sent to the customer (block 710). In either case, the customer will proceed to the maintenance provider's location (block 712). The vehicle is picked up and the transaction is completed (block 714). The maintenance provider signs into the System to enter details about the maintenance transaction (block 716). The System updates the order details and status of the maintenance transaction (block 718).

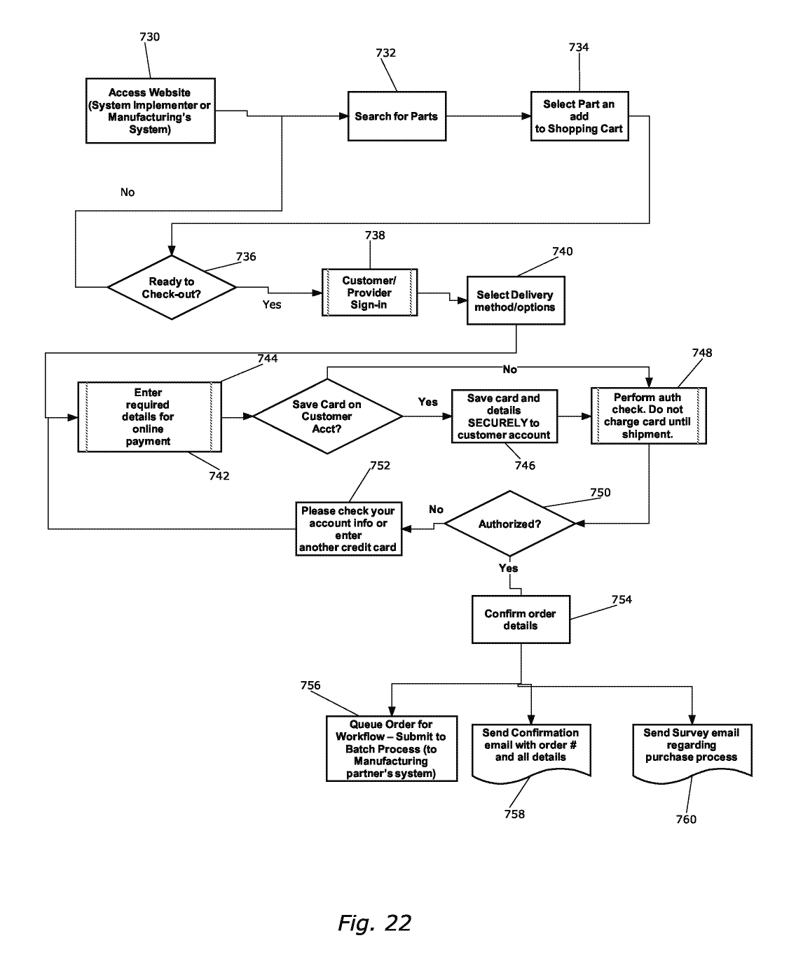

FIG. 22 provides a flowchart illustrating the steps involved in purchasing parts. As depicted in block 730, the customer accesses the System's website or the parts manufacturer's website to order parts. The System prompts the customer to identify the parts and then commences a search (block 732). The System then prompts the user to select parts for purchase (block 734). The System then prompts the customer to see if he is ready to checkout (block 736). If not, the System loops back to the steps of block 732. If the customer is ready to checkout, the customer is prompted to login to the System (block 738). The System then presents the customer with various delivery options. The customer is prompted to select a delivery option (block 740). The System then prompts the user to enter details for the payment method (block 742). The System prompts the customer to indicate if he would like the payment information retained on the System (block 744). If the information is to be retained, the System securing saves the information (block 746). In either case, the System performs an authorization check (blocks 748 and 750). If the payment is not authorized, the customer is prompted to enter alternative payment information (block 752). If the payment is authorized, the System prompts the customer to confirm the order details (block 754). The System then places the order on the manufacturer workflow queue (block 756). This is usually done in a batched manner at predetermined intervals (e.g., end of the day, end of the week, every hour, etc) (block 758). The System sends a confirmation email to the customer (block 760). Finally, the System sends a survey email to the customer soliciting feedback about the parts purchasing process (block 762).

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An online system for vehicle retail sales, distribution, and post-sales maintenance, comprising a computer processor operable to:
provide vehicle-related information to a customer;
receive vehicle-related selections from the customer specifying a vehicle that the customer is to purchase, one or more of the vehicle-related selections requiring products or services from a business partner;
receive a vehicle service request from the customer, the service request identifying a business partner that is a service provider;
communicate relevant selections to business partners;
receive an order submission from the customer;
receive a bridge vehicle request from the customer, the bridge vehicle being a loaner or lease vehicle; and
process the order submission.

2. The system of claim 1 wherein the computer processor is operable to communicate vehicle-related selections directly to a vehicle manufacturer without going through a dealer or middleman, the vehicle manufacturer building a vehicle conforming to the vehicle-related selections.

3. The system of claim 1 wherein the computer processor is operable to provide financing options to the customer and to receive financing selections from the customer.

4. The system of claim 1 wherein the computer processor is operable to provide a list of maintenance providers to the customer and to receive a maintenance provider selection from the customer, each maintenance provider being a business partner authorized to provide warranty service.

5. The system of claim 1 wherein the computer processor is operable to provide online chatting capability between the customer and support personnel.

6. The system of claim 1 wherein the computer processor is operable to receive a credit card application and to provide approval for a credit card to be used in purchasing a vehicle.

7. The system of claim 1 wherein the computer processor is operable to receive customer ratings and comments regarding service providers.

8. The system of claim 1 wherein the business providers are selected from the group consisting of test drive providers, delivery providers, finance providers, insurance providers, trade-in providers, and bridge car providers.

9. The system of claim 1 wherein the computer processor is operable to store customer related data in a database.

10. An online system for vehicle retail sales, distribution, and post-sales maintenance, comprising a computer processor operable to:
provide vehicle-related information to a customer;
receive vehicle-related selections from the customer specifying a vehicle that the customer is to purchase, one or more of the vehicle-related selections requiring products or services from a business partner;
receive a vehicle service request from the customer, the service request identifying a business partner that is a service provider;
communicate relevant selections to business partners;
receive an order submission from the customer;
receive a bridge vehicle request from the customer, the bridge vehicle being a loaner or lease vehicle;
process the order submission; and
receive evaluations for a business partner providing a service to the customer.

11. The system of claim 10 wherein the computer processor is operable to communicate vehicle-related selections directly to a vehicle manufacturer without going through a dealer or middleman, the vehicle manufacturer building a vehicle conforming to the vehicle-related selections.

12. The system of claim 10 wherein the computer processor is operable to provide financing options to the customer and to receive financing selections from the customer.

13. The system of claim 10 wherein the computer processor is operable to provide a list of maintenance providers to the customer and to receive a maintenance provider selection from the customer, each maintenance provider being a business partner authorized to provide warranty service.

14. The system of claim 10 wherein the computer processor is operable to provide online chatting capability between the customer and support personnel.

15. The system of claim 10 wherein the business providers are selected from the group consisting of test drive providers, delivery providers, finance providers, insurance providers, trade-in providers, and bridge car providers.

16. An online method for vehicle retail sales, distribution, and post-sales maintenance, the method comprising:
providing vehicle-related information to a customer;
receiving vehicle-related selections from the customer specifying a vehicle that the customer is to purchase, one or more of the vehicle-related selections at least partially requiring products or services from a business partner;
communicating relevant selections to business partners;
receiving an order submission from the customer;
receiving a bridge vehicle request from the customer, the bridge vehicle being a loaner or lease vehicle; and
processing the order submission.

17. The method of claim 16 further comprising receiving a vehicle service request from the customer, the service request identifying a business partner that is a service provider.

18. The method of claim 16 further comprising communicating vehicle-related selections directly to a vehicle manufacturer without going through a dealer or middleman, the vehicle manufacturer building a vehicle conforming to the vehicle-related selections.

19. The method of claim 16 further comprising providing financing options to the customer and receiving financing selections from the customer.

20. The method of claim 16 further comprising a list of maintenance providers to the customer and receiving a maintenance provider selection from the customer, each maintenance provider being a business partner authorized to provide warranty service.

21. The method of claim 16 further comprising providing online chatting capability between the customer and support personnel.

22. The method of claim 16 wherein the business providers are selected from the group consisting of test drive providers, delivery providers, finance providers, insurance providers, trade-in providers, and bridge car providers.
